(19) United States
(12) Patent Application Publication
(10) Pub. No.: US 2025/0235777 A1
(43) Pub. Date: Jul. 24, 2025

(54) METHOD AND SYSTEM FOR CONTROLLING THE MODE OF COMPUTER GAMES DISPLAYED ON A COMPUTING DEVICE

(71) Applicant: LUDEO INC., El Segundo, CA (US)

(72) Inventors: Asaf Gazit, Tel Aviv (IL); Oded Levinger, Tel Mond (IL); Yoav Pipkevitch, Ramat Gan (IL); Ziv Levin, Tel Aviv (IL)

(21) Appl. No.: 19/028,272

(22) Filed: Jan. 17, 2025

Related U.S. Application Data
(60) Provisional application No. 63/624,032, filed on Jan. 23, 2024.

(51) Int. Cl. A63F 13/2145

(52) U.S. Cl. CPC A63F 13/2145

(57) ABSTRACT

There are provided methods and devices such as handheld computing device, comprising: a display configured to present one or more media items; one or more sensors configured and enabled to detect one or more movements of the handheld computing device or one or more movements of a user; one or more processors communicatively coupled to the display and to the one or more sensors, wherein the one or more processors are configured and enabled to: receive one or more movement signals from the one or more sensors; and process the one or more movement signals to yield one or more movement types; and automatically transition the mode of one or more computer games from a ‘view mode’ to ‘play mode’ based on the detected one or more movement types or vice versa, wherein the one or more computer games are launched before or during the transition.

### CROSS-REFERENCE

The present application claims priority to U.S. Provisional Application Ser. No. 63/624,032, filed on Jan. 23, 2024, entitled “METHOD AND SYSTEM FOR CONTROLLING THE MODE OF COMPUTER GAMES DISPLAYED ON HANDHELD COMPUTING DEVICE”, which is incorporated herein by reference in its entirety.

### TECHNICAL FIELD

The present invention relates generally to computer games displayed on handheld devices, and more specifically, but not exclusively, to controlling the gaming mode of the displayed computer games.

### BACKGROUND OF THE INVENTION

The computer game industry has undergone dynamic transformations, leveraging advances in computing power to craft immersive and realistic gaming experiences. Online gaming has thrived, and cloud-based gaming systems, featuring remote processing servers and local thin clients, are gaining prominence for their enhanced accessibility. Game users can rapidly browse and scroll through their handheld device screens to view various games before making a selection. Gaming enthusiasts anticipate a seamless exploration of diverse gaming options through various computer game apps, readily available on platforms like Steam™, GOG™, Epic™ Games Stores, Google™ Play Store and Apple™ store, each boasting an extensive catalog of games.

However, despite this rich array of options, the user experience for computer game users during the process of selecting and playing a game is marred by inconveniences. However, the current user experience suffers from two critical problems. First, users must navigate through complex menus and multiple button presses just to try a game, creating friction in the game discovery process. Second, when users find an interesting game, they face frustrating wait times for downloads and installations before they can start playing.

Current solutions attempt to address these problems through game previews and cloud streaming, but these approaches still require users to manually navigate through multiple steps to transition from browsing to playing. For example, even with cloud gaming, users must typically click through several confirmation screens and wait for server connections before gameplay can begin. This multi-step process interrupts the natural flow of game discovery and creates a barrier between interest and engagement.

For example, users experience frustration during prolonged download processes, similar to waiting for large files to download over slow internet connections. Additionally, envision the intricate navigation through multiple menu options and prompts, reminiscent of the cumbersome process of configuring settings on a device with a complex user interface for the user to start playing the selected computer game.

When users make quick decisions about game selection and have limited patience, there emerges a need for an innovative system and method. This solution should be characterized by brevity, simplicity, and an intuitive design to ensure a heightened user experience. The goal is to empower computer game users to swiftly and decisively select and engage with their desired games.

### SUMMARY OF THE INVENTION

The present invention solves these problems by eliminating the boundary between browsing and playing games through natural device movements. A user browsing games can instantly begin playing by simply, for example, rotating their device or making a gesture, with no additional button presses or menu navigation required. The system predicts and pre-loads games in the background, enabling truly immediate gameplay when the user shows interest. This creates a fluid, natural experience where games can be sampled as easily as they can be browsed.

Specifically, the invention provides a handheld computing device that automatically transitions between a passive ‘view mode’ for browsing games and an active ‘play mode’ for gameplay based on device movements or gestures. The system launches games preemptively before or during this transition, eliminating traditional loading screens and wait times. This direct, gesture-based interaction represents a fundamental shift in how users discover and engage with games on computing devices.

In accordance with a first embodiment of the present invention, there is provided a display configured to present one or more media items; one or more sensors configured and enabled to detect one or more movements of the handheld computing device or one or more movements of a user; one or more processors communicatively coupled to the display and to the one or more sensors, wherein the one or more processors are configured and enabled to: receive one or more movement signals from the one or more sensors; and process the one or more movement signals to yield one or more movement types; and automatically transition the mode of one or more computer games from a ‘view mode’ to ‘play mode’ based on the detected one or more movement types or vice versa, wherein the one or more computer games are launched before or during the transition.

In an embodiment, the ‘view mode’ comprises a passive state allowing observation and scrolling through media items representing the one or more computer games without direct interactive control and the ‘play mode’ comprises an active state enabling direct user control and interaction with the one or more computer games.

In an embodiment, the one or more computer games are related, respectively, to one of the one or more media items.

In an embodiment, the one or more computer games are not directly related to the one or more media items.

In an embodiment, the one or more computer games are linked, respectively, to the one or more media item based on one or more calculation steps, the calculations steps are selected from the group consisting of: randomization, user history, available computer games, preferences.

In an embodiment, the one or more movements are limited by a movement threshold.

In an embodiment, the one or more movements of the handheld computing device or one or more movements of a user are one or more gestures or one or more rotations.

In an embodiment, the one or more gestures of the user are selected from the group consisting of: Single-Point Contact Gestures; Multi-Point Contact Gestures; Edge-Initiated Gestures; Motion-Based Gestures; one or more taps on the computing device.

In an embodiment, the one or more rotations of the handheld computing device comprise an X degrees threshold rotation, wherein X is a configurable parameter.

In an embodiment, the one or more rotations are rotations of the handheld computing device or the display from a vertical state of the handheld computing device relative to a reference point to a horizontal state of the handheld computing device relative to the reference point, or vice versa.

In an embodiment, the vertical state the display is in a ‘view mode’ and in the horizontal state the display is in ‘play mode’ or vice versa.

In an embodiment, the one or more computer games are selected from the group consisting of: highlight gameplay moments, mini-games, Playable Gameplay Highlight(s) (PGH), games with specific constraints, computer games having derivative forms that maintain interactive entertainment as their primary purpose.

In an embodiment, the media items comprise one or more representations of the computer games, selected from the group consisting of: graphics, text, video, images, emojis, stickers, VR (virtual reality), AR (augmented reality), dynamic representations of short preview videos and clips.

In an embodiment, the one or more computer games are partially or completely received or downloaded from an external or local storage medium.

In an embodiment, the one or more computer games are received or downloaded using streaming techniques.

In an embodiment, the streaming techniques are Cloud Gaming Streaming services.

In an embodiment, the one or more computer games are received or downloaded using a hybrid combination comprising: downloading part of the one or more computer games or part of elements in the one or more computer games from an external or local storage medium; and downloading part of the one or more computer games or part of the elements in the computer games using streaming techniques.

In an embodiment, the one or more processors comprise a prediction module, the prediction module is configured and enabled to: predict which the one or more computer games will be selected and played by the user.

In an embodiment, the one or more predicted computer games are downloaded.

In an embodiment, the one or more predicted computer games are downloaded using a hybrid combination download.

In an embodiment, the hybrid combination comprises: downloading part of the one or more computer games or part of elements in the one or more computer games from an external or local storage medium and part of the one or more computer games or part of the elements in the one or more computer games are downloaded using streaming techniques.

In an embodiment, the one or more sensors are selected from the group consisting of: a gyroscope; an accelerometer; a magnetometer; a sensor capable of detecting, measuring or determining the orientation, motion, acceleration, angular velocity, or movement of the handheld computing device.

In an embodiment, the handheld computing device comprises a storage unit for storing the one or more media items or one or more computer games.

In accordance with a second aspect of the present invention, there is provided a method comprising: displaying one or more media items on a display of a handheld computing device; detecting, by one or more sensors communicatively coupled to one or more processors, one or more movements of the handheld computing device or one or more movements of a user while at least one media item is displayed on the display of the handheld computing device, wherein the movements comprise rotations or gestures; identifying the movement type by the one or more processors; automatically transitioning the mode of one or more computer games from a ‘view mode’ to ‘play mode’ based on the one or more movement types or vice versa, wherein the one or more computer games are launched before or during the transition.

In an embodiment, the one or more movements are rotation movements or gestures.

In an embodiment, the one or more rotations are rotations of the handheld computing device or the display from a vertical state relative to a reference point to a horizontal state relative to a reference point, or vice versa.

In an embodiment, the method comprises downloading or receiving the one or more computer games partially or completely from an external or local storage medium.

In an embodiment, the method comprising downloading or receiving the one or more computer games using streaming techniques.

In an embodiment, the method comprises downloading or receiving the one or more computer games using a hybrid combination of downloading part of the one or more computer games or part of elements in the one or more computer games from an external or local storage medium and part of the one or more computer games or part of the elements in the one or more computer games using streaming techniques.

In an embodiment, the method comprises predicting which computer game of the one or more computer games will be selected and played by the user; and downloading the predicted computer game.

In an embodiment, the one or more sensors are in communication with the handheld computing device.

In an embodiment, the one or more sensors and one or more processors are sensors and processors of the handheld computing device.

In an embodiment, the one or more movements are limited by a movement threshold.

In an embodiment, the one or more movements are one or more rotations of the handheld computing device.

In an embodiment, the one or more rotations of the handheld computing device comprise an X % degrees threshold rotation, wherein X is a parameter that can be configured to any degree value, such as, but not limited to, 90 or 270 degrees, relative to a reference point.

In an embodiment, the handheld computing device is positioned in a vertical state relative to a reference point, and wherein the one or more sensors are configured and enabled to detect a rotation of the handheld device from the vertical state to a horizontal state or vice versa, and wherein the processor is configured and enabled to: receive one or more rotation signals from at least one sensor of the one or more sensors; and in response to the received one or more rotation signals from the at least one sensor, launch the computer game displayed on the handheld computing device screen.

In an embodiment, the one or more computer games are selected from the group consisting of: highlight gameplay moments, minigames, presentation of one or more images of the one or more computer games, computer clips of the one or more computer games, highlights, demos associated with the one or more computer games, complete computer game of each or some of the one or more computer games, specific segments thereof, a demonstration of the one or more computer games derivative of computer games, Playable Gameplay Highlight(s) (PGH), such as PGH which are limited for example by rules, time, space and the like.

In an embodiment, the computer games are partially or completely received or downloaded from an external or local storage medium.

In an embodiment, the computer games are received or downloaded using streaming techniques.

In an embodiment, the streaming techniques are Cloud Gaming Streaming service.

In an embodiment, the processor comprises a prediction program, the prediction program is configured and enabled to: predict which computer game of the displayed computer games will be selected and played by the user and download the predicted computer game using one or more prediction methods, wherein the prediction methods include, but are not limited to: machine learning algorithms analyzing user behavior patterns, historical game selection data, current user session data, game popularity metrics, user preferences, and contextual data. The prediction program may operate continuously in the background, updating predictions in real-time as user behavior changes.

In an embodiment, the prediction program is further configured to trigger preloading of predicted computer games, minigames, demos, Playable Gameplay Highlights (PGH), or game derivatives on remote cloud gaming servers. The preloading process comprises: (1) transmitting prediction data to the cloud gaming servers; (2) initiating game instance preparation on the server side; (3) allocating necessary computing resources; and (4) preparing game state and assets, thereby reducing latency when the user initiates gameplay. The prediction program may maintain a priority queue of potentially required games on the cloud servers, dynamically updating server-side resource allocation based on prediction confidence levels and available server capacity.

In an embodiment, the predicted computer game is downloaded.

In accordance with a third aspect of the present invention, there is provided a method comprising: displaying a set of one or more computer games on a screen of a handheld computing device; detecting one or more movements of the handheld device by one or more sensors of the handheld computing device while one computer game of the set of computer games are displayed on the screen; determine the movement type by one or more processors of the handheld computing device; transition the mode of the displayed computer game from a ‘view mode’ to ‘play mode’ based on the detected and determined movement.

### BRIEF DESCRIPTION OF THE DRAWINGS

A better understanding of the features and advantages of the present disclosure will be obtained by reference to the following detailed description that sets forth illustrative embodiments, in which the principles of embodiments of the present disclosure are utilized, and the accompanying drawings.

FIG. 1A illustrates a user holding a handheld mobile computing device and watching a computer game displayed on the screen of the computing device in portrait mode, in accordance with some embodiments of the present disclosure;

FIG. 1B illustrates a user holding a handheld mobile computing device and playing a computer game displayed on the screen of the computing device in landscape mode, in accordance with some embodiments of the present disclosure;

FIG. 1C illustrates various rotation options, in accordance with some embodiments of the present disclosure;

FIG. 1D shows a computing device including a single media item displayed on the screen of the computing device in a ‘view mode’, in accordance with some embodiments of the present disclosure;

FIG. 1E shows another example of launching one or more computer games related to displayed media items based on identifying movements, such as a rotation of a computing device or gestures, in accordance with some embodiments of the present disclosure;

FIG. 2A and FIG. 2B illustrates various options and system architectures for downloading, streaming, and playing the computer games of FIG. 1A and FIG. 1B, in accordance with some embodiments of the present disclosure;

FIG. 3A is a block diagram of an exemplary computing system, in accordance with some embodiments of the present disclosure;

FIG. 3B is a block diagram of an exemplary computer system comprising a prediction module, in accordance with some embodiments of the present disclosure;

FIG. 4 illustrates a flowchart of a method for automatically switching the mode of one or more computer games displayed on a computing device from a ‘viewing mode’ to ‘play mode’ based on a detected movement of the computing device, in accordance with some embodiments of the present disclosure;

FIG. 5A illustrates a flowchart of a computer game automatic-mode-change and prediction method, in accordance with some embodiments of the present disclosure;

FIG. 5B shows an example of multiple media items displayed on a handheld computing device, in accordance with other embodiments of the present disclosure; and

FIG. 6 illustrates a detailed flowchart of a computer game automatic-mode-change method, in accordance with other embodiments of the present disclosure.

### DETAILED DESCRIPTION OF THE INVENTION

In the following description, various aspects of the invention will be described. For the purposes of explanation, specific details are set forth in order to provide a thorough understanding of the invention. It will be apparent to one skilled in the art that there are other embodiments of the invention that differ in details without affecting the essential nature thereof. Therefore, the invention is not limited by that which is illustrated in the figure and described in the specification, but only as indicated in the accompanying claims, with the proper scope determined only by the broadest interpretation of the claims.

Prior to the detailed description of the invention being set forth, it may be helpful to set forth definitions of certain terms that will be used hereinafter.

The term ‘game(s)’ or ‘computer game(s)’ as used herein and through the specification and claims encompasses all forms of interactive digital entertainment executed on computing devices. This includes traditional computerized games such as two-dimensional and three-dimensional games, as well as both video games and computer programs designed for interactive entertainment. The scope extends to first-person and third-person perspectives, single player and multiplayer experiences, competitive and non-competitive formats, spanning genres such as racing, shooting, turn-based strategy (e.g., chess), and sports. The definition further encompasses advanced interactive experiences utilizing virtual reality (VR) and augmented reality (AR) technologies, whether scored or unscored, including board game adaptations, competition formats, tournament structures, gambling applications, and prize-based games. Additionally, the term includes non-competitive virtual “experiences” such as VR/AR musical concerts or virtual territory exploration. The definition also encompasses derivatives of traditional computer games, including but not limited to: mini-games, Playable Gameplay Highlight(s) (PGH), games with specific constraints (rules, time, space), and any other derivative forms that maintain interactive entertainment as their primary purpose.

The term ‘Playable Gameplay Highlight(s) (PGH)’ refers to an interactive recreation of specific gameplay moments that allows subsequent users to experience and engage with notable gaming achievements or sequences. These segments represent curated content derived either from a player's personal gameplay or from historically significant moments in the original game. The distinguishing characteristic of PGH is that it enables any user to assume the role of the original player within that specific gameplay context, complete with the original parameters, challenges, and objectives. These experiences are temporally bounded, typically aligning with the duration of the original gameplay sequence, and may incorporate various gameplay elements: defined objectives, specific constraints based on the original gameplay conditions, and an automated scoring system that evaluates user performance against predetermined metrics. The scoring system provides quantitative feedback on how well users replicate or improve upon the original gameplay sequence. PGHs can be limited by various factors including but not limited to: temporal constraints (matching the original sequence duration), spatial boundaries (specific game areas or environments), rule modifications (specific gameplay mechanics or restrictions), and performance metrics (scoring thresholds or achievement criteria). An instance of PGH is exemplified in the PCT filed patent application number PCT/IL2022/051205, titled ‘USER-GENERATED REPLAYABLE GAMING CONTENT UTILIZING REGAMIFICATION DATA,’ provisional application No. 63/598,654, entitled ‘USER-GENERATED REPLAYABLE GAMING CONTENT UTILIZING REGAMIFICATION DATA,’ and U.S. application Ser. No. 18/660,841, filed on May 10, 2024 entitled “USER-GENERATED REPLAYABLE GAMING CONTENT UTILIZING REGAMIFICATION DATA” all submitted by the present applicant. The contents of these applications are hereby incorporated by reference.

The term ‘Highlight’ or ‘Highlights’ refers to specifically identified segments within a computer game's gameplay that possess particular significance or merit recreation as a PGH. These segments are characterized by notable achievements, exceptional skill demonstrations, or unique gaming moments that warrant preservation and sharing. A Highlight involves both temporal and contextual elements: the specific timestamp or time interval during which the notable gameplay occurs, and the surrounding game state that makes the moment significant. For example, a Highlight might encompass a duration of 20 seconds in an NBA computer game (e.g., NBA 2K24) where a player maintains uncontested ball possession, executes a complex maneuver, or achieves a remarkable score. The identification of Highlights may be based on various criteria including but not limited to: player performance metrics, achievement of specific game objectives, demonstration of exceptional skill or strategy, rarity of the accomplished feat, or the overall impact on the game outcome. These Highlights serve as the foundation for creating PGHs, providing the base content from which interactive, playable experiences can be developed.

The term ‘demo game(s)’ or ‘demos’ refers to purposefully limited versions of computer games designed to showcase core gameplay elements while restricting full access. These demonstrations serve as interactive previews, allowing potential users to experience key features and mechanics before committing to the complete game. Demos are characterized by specific limitations that may include: temporal restrictions (limiting play duration), spatial constraints (access to specific levels or areas), feature limitations (subset of available gameplay mechanics), or content boundaries (restricted character/item access). The limitations are strategically implemented to both demonstrate the game's value proposition and maintain differentiation from the full version. Demos may incorporate modified rule sets, alternative gameplay loops, or specialized tutorial elements designed specifically for demonstration purposes. These versions maintain the essential character of the original game while serving the distinct purpose of user evaluation and gameplay preview.

The term ‘users’ or ‘user’ or ‘gamer’ or ‘gamers’ encompasses any entity engaging with computer games or related content, including both individual users and collective groups. This definition extends to casual players, competitive gamers, content creators, and observers, regardless of skill level, engagement frequency, or platform preference. The term includes both human players and, where applicable, AI or automated systems interacting with game content.

The term ‘viewing area’ or ‘view area’ as used herein and through the specification and claims should be understood to encompass a designated portion of the display (e.g. display screen of for example a computing device) that is capable of presenting a subset of data, including text, graphics, images, videos, or any combination thereof, such as content from a computer game or multimedia content, at a given time. This area can dynamically adjust or update to bring new data into view as required, either automatically or in response to user interaction (e.g., scrolling, swiping, tapping). The viewing area may be defined by software parameters, hardware dimensions, or a combination thereof, and is typically bounded by visible screen dimensions or a pre-configured virtual boundary (e.g. either constrained or dynamic boundary) that determines the content displayed. The boundary configuration can adapt based on display orientation, user preferences, and content requirements.

The term ‘scrolling’ as used herein and throughout the specification and claims refers to moving displayed content across a viewing area on a display screen, where such content may include data, images, videos, and/or graphics relating to one or more computer games, PGHs, mini-games, or demos, such that a new set of data (e.g., text or graphics) is brought into view in the viewing area. The scrolling operation functions such that when the viewing area reaches capacity, each new set of data appears at the edge of the viewing area while existing sets of data move over one position. This means that a new set of data appears for each set of data that moves out of the viewing area. The scrolling function enables users to view consecutive sets of computer games that are currently outside of the viewing area. The viewing area may comprise the entire viewing area of the display screen or only a portion thereof (e.g., a window frame).

In some embodiments, the scroll functionality allows a continuous view of a viewing area (e.g., designated display region). This capability enables a user to peruse segments of data situated spatially elsewhere within the set of data, namely above, below, to the left, or to the right of the current viewport. The next set of data may be positioned at the top or bottom of the viewing area, according to the implementation or user preference. Advantageously, the user can control exactly which portions of the data they can view, and at which pace.

In accordance with embodiments, scrolling may be implemented vertically (up or down), horizontally (left or right), or in a bottom/up direction. In the case of vertical scrolling, when a user scrolls down, each new set of computer games appears at the bottom of the viewing area and all other sets of computer games move up one position. If the viewing area is full, the top set of computer games moves out of the viewing area. Similarly, when a user scrolls up, each new set of computer games appears at the top of the viewing area and all other sets of computer games move down one position. If the viewing area is full, the bottom set of computer games moves out of the viewing area. In the case of bottom/up scrolling, content progressively appears from the bottom of the viewing area and moves upward, regardless of scroll direction. The scrolling may also be implemented as a hybrid approach, where there is a mixture of vertical, horizontal, and bottom/up scrolling types, such as when computer game images or data are displayed in multiple directions along the display screen.

The term ‘media item’ or ‘media items’ refers to digital content that can be displayed and interacted with on a computing device, primarily encompassing one or more representations of the computer games such as graphics, text, video, images, emojis, stickers, VR (virtual reality), AR (augmented reality), or dynamic representations like short preview videos and clips. The representations of these media items may take various forms and in some cases may not be directly related to the underlying computer game itself, serving instead, for example, as references or indicators of the content.

The term ‘view mode’ or ‘viewing mode’ refers to a user interface state in which the user can actively watch and scroll through one or more media items representations. During this ‘viewing mode’, the user typically engages in passive observation of computer games by employing for example a scrolling gesture (e.g., single-hand scrolling gesture) to navigate through and switch between different media items representations in a displayed list. Users commonly hold the computing device in a vertical orientation with respect to a reference point, similar to a “reading a book's page” orientation, where the device's height usually exceeds its width. This user preference is attributed to the familiarity and comfort associated with the vertical positioning, which allows for convenient thumb-based scrolling and enhances the overall user experience in exploring and selecting computer games. The mode serves as an initial discovery interface, enabling users to efficiently browse and evaluate content before committing to more intensive interaction modes, facilitating a natural progression from content discovery to active engagement.

In accordance with some embodiments, the term ‘view mode’ refers to a passive interface state where users browse and evaluate games through scrollable media representations. In this mode, users can observe game content through for example previews, screenshots, or clips, but sometime cannot directly interact with the games themselves. The display, in some cases, maintains a vertical orientation, similar to reading a book, facilitating natural scrolling and content discovery.

The term ‘play mode’ as used herein and through the specification and claims refers to an active interaction state where the user can directly control and engage with the computer game through input mechanisms such as touch, motion, or gestures. In ‘play mode’, the computer game is actively executing and responding to user inputs, allowing gameplay actions such as character movement, selection of options, scoring points, or achieving game objectives. This is in contrast to ‘view mode’ which represents a passive state where users can only observe media items representing the computer games without direct interactive control or gameplay capabilities. The transition between these modes represents a shift from passive observation to active gameplay participation. In this mode, the game is actively executing and responding to user inputs, enabling full gameplay functionality. The transition between these modes represents the key innovation of this invention—an immediate shift from passive observation to active gameplay triggered by natural device or user movements.

The term ‘transition’ refers to the automated process of switching between view and play modes, or vice versa, characterized by immediate response to detected movements, and for example pre-loading of game content, seamless visual transformation, and preservation of user context. This process happens automatically and instantly upon detection of the specified movement, ensuring a fluid user experience without traditional loading screens or wait times.

The term ‘movement(s)’ encompasses device rotations ranging for example from 0 to 360 degrees on any axis, touch gestures including swipes and taps, motion gestures such as shaking or tilting, and combinations thereof. Each movement type can trigger the transition between view and play modes based on configurable parameters that consider factors such as speed, intentionality, and completion of the movement.

The term ‘rotation’ or ‘rotations’ as used herein and through the specification and claims should be understood to encompass any movement of a computing device, such as a handheld computing device, for example around one or more spatial axes. The term “rotation(s)” includes, tilts, and reorientations, collectively representing alterations in the spatial positioning of the computing device.

In accordance with embodiments, the term “rotation” extends beyond standalone rotational movement, encompassing a spectrum of possibilities involving its integration with various forms of gestures or motions. This may involve actions such as shaking, lifting, dropping, tilting, movement detection, twisting, turning, spinning, tapping, as well as any conceivable amalgamation of these movements or other related rotational variations.

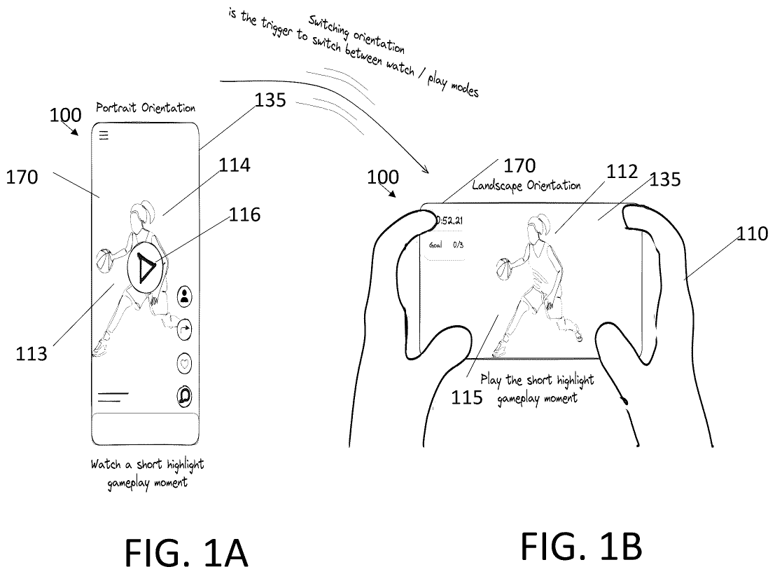

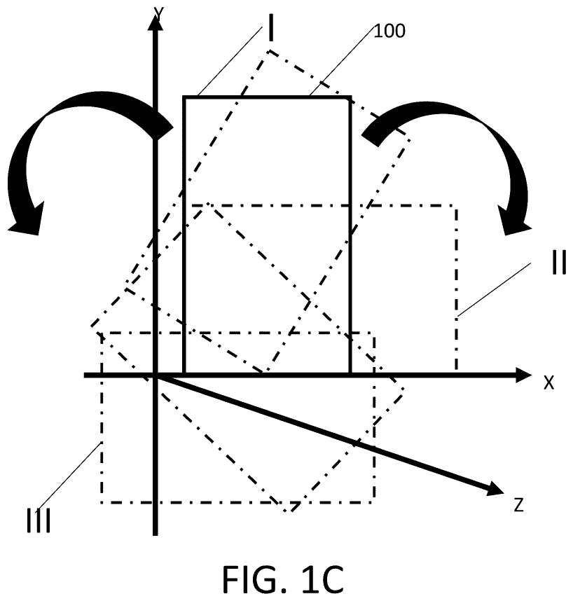

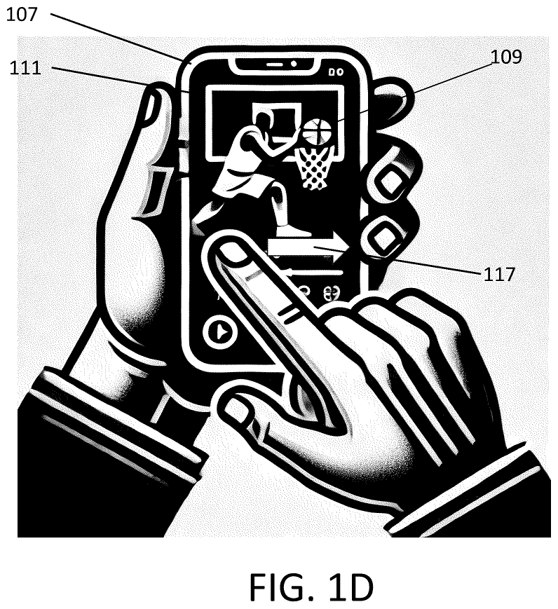

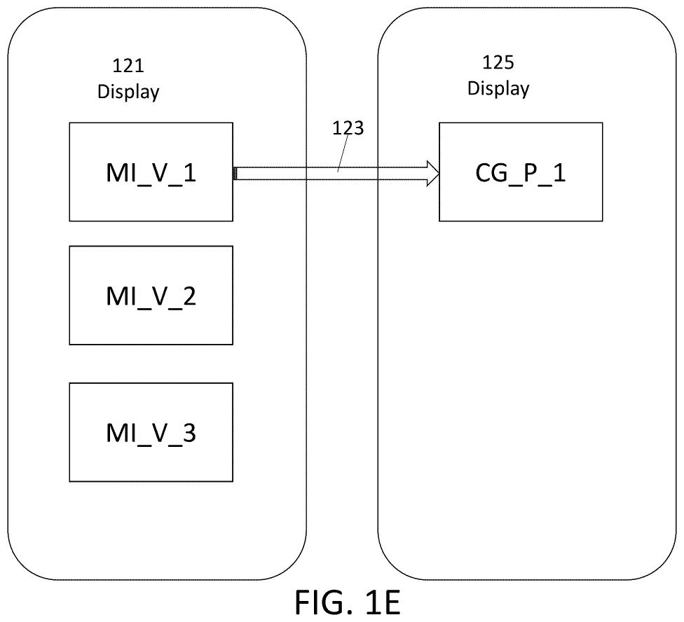

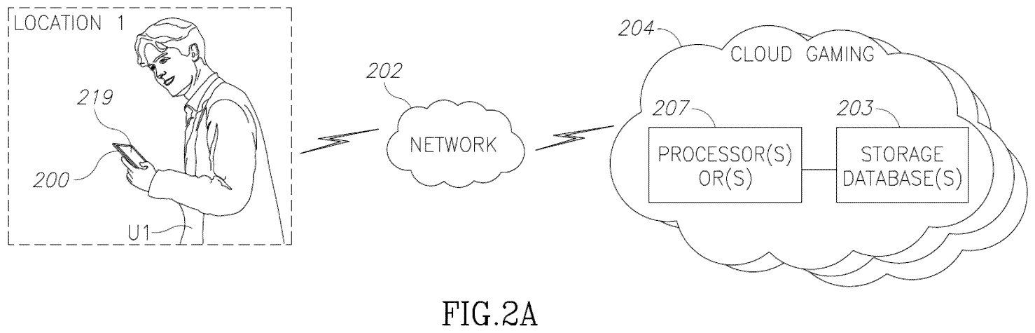

Additionally, the term ‘rotation’ as used herein throughout the specification and claims refers to various orientations of a computing device 100 within the range of 0 to 360 degrees. The rotation may occur around any axis or combination of axes. For instance, as illustrated in FIG. 1C, when the computing device 100 is held in a vertical position parallel to the X-Y plane of a Cartesian X-Y-Z axis, the orientation from a vertical position to a horizontal position may include a 90-degree rotation from state I to state II (e.g. clockwise rotation) and/or a 270-degree rotation (e.g. anti clockwise rotation) from state I to state III. Since the conventional 360-degree system is cyclical (i.e., a 360-degree rotation is equivalent to 0 degrees), any rotation can be expressed as either a positive or negative angular value. For example, a clockwise rotation of 270 degrees is equivalent to a counterclockwise rotation of 90 degrees (expressed as −90 degrees). The rotation can further include tilting, flipping, or any combination thereof, allowing for versatile positioning within the defined angular range

In some cases, the rotation may be of more than 90 degrees or less than 270 degrees (equivalent to minus 90 degrees, and since it's minus it is typically more than minus 90 degrees, for example minus 95 degrees that's equivalent to 265 degrees, as shown in FIG. 1C).

In some cases, the rotation may involve movement along other planes such as movements (e.g. involving its integration with various forms of gestures or motions. as described above) along the Y-Z plane and/or plane X-Z and any plane of the Cartesian X-Y-Z axis.

In some cases, a rotation may include or may be a sequence of more than one movement.

In some cases, a rotation may be or may include movements of the computer device clockwise or anticlockwise.

In some cases, the one or more rotations of the computing device comprise an X % degrees threshold rotation, wherein X is a parameter that can be configured to any degree value, such as, but not limited to, 90 or 270 degrees, relative to a reference point. In some cases, the rotation may be of more than 90 degrees or less than 270 degrees (equivalent to minus 90 degrees, and since it's minus it should be more than minus 90 degrees—for example minus 95 degrees that's equivalent to 265 degrees).

In an embodiment, the movement detection comprises: a continuous monitoring of device orientation through one or more sensors; a time window for movement detection that spans from the moment a media item is displayed until X seconds after any detected movement, where X is a configurable parameter; and a movement validation process that confirms the intentionality of the movement based on factors including, but not limited to, movement speed, movement continuity, and movement completion. The movement detection system may operate with configurable sensitivity thresholds to accommodate different user preferences and device characteristics.

The present invention relates to improving how users interact with computer games on for example computing devices. More specifically, it addresses the challenge of transitioning between browsing games and playing them by introducing a movement-based interface that eliminates traditional navigation steps and waiting times. The invention enables users to instantly switch from viewing a game to playing it through natural device movements or gestures, fundamentally changing how mobile games are discovered and experienced.

In other words, the present invention relates generally to computer games/media items displayed on computing devices, and specifically, but not exclusively, to controlling the gaming mode of the displayed computer games/media items. More specifically, the present invention relates to methods and systems for transitioning between viewing and play modes of computer games/media items displayed on computing devices such as handheld computing devices (e.g. portable handheld computing devices). The methods and systems include detecting the movement of the handheld device, such as a rotation movement of the computing device and/or user's movement such as user's gesture while holding the computing device. This movement triggers an automatic activation of a media item displayed on the handheld device related to a computer game, facilitating an optimal and natural gaming experience.

FIG. 1A illustrates a computing device such as a handheld computing device 100 including one or more media items, such as media item 114 including presentations, such as graphical presentations of computer games. For example a preview of computer game 112 displayed on a display such as the display screen 170, for example a touch screen of the computing device 100, in accordance with embodiments of the invention.

By way of example, the display screen 170, during operation, may display a list of media items (e.g., including for example the preview of computer game 112). A user is able to for example linearly scroll through the list of media items by moving his or her finger across the touch screen. As the finger moves across the touch screen, the displayed media items from the list of media items are varied such that the user is able to effectively scroll through the list of media items. In most cases, the user is able to accelerate their traversal of the list of media items by moving his or her finger at greater speeds.

In accordance with the present invention, a media item may include or may be related or linked to the computer game 112, such as a streamed computer game, where the content is delivered for example in real-time over a network and interacted with by the user via computational devices such as device 100.

In some cases, the one or more computer games are related, respectively, to one or more media items.

In some cases, the one or more computer games are not directly related to the one or more media items and are linked, respectively, to the one or more media items based on for example one or more calculation steps, the calculation steps are selected from the group consisting of: randomization, user history, available computer games, preferences.

According to some embodiments, the computer games 112 may be cloud-based or streamed computer games.

In some embodiments, the media item 114 includes a representation of the computer game 112 rather than the actual game content. The representation may be or may include any form of representation such as a graphic, text, video, image, dynamic representation such as a short preview video, or clip or the like which is related to the computer game 112. For example, the representation may be a randomly selected one or more images from the media item. As shown in FIG. 1A, the representation may include the first frame of the computer game, however the representation may include only a text title of the game such as “NBA' game, or any other media item that can be related and/or represent the computer game 112.

In accordance with embodiments of the present invention, the computing device 100 is configured and enabled to recognize one or more movements such as rotation movements applied to the computing device 100 or a user movement and to trigger and/or control one or more aspects of one or more displayed media items such as computer 112 based on the detected movements.

In accordance with systems and methods of the invention as shown in FIG. 1B, in response to the user's movement of for example the computing device 100 or hand such as the rotation movement of the computing device 100 from a vertical position (e.g. a screen portrait position) shown in FIG. 1A to a horizontal position (e.g. screen landscape position) shown in FIG. 1B, or as a result of hand gesture, the mode of the media items (e.g. media item 114) is switched from a ‘view mode’ 113 to a ‘play mode’ 115 and a user may immediately play the computer game 112. The switch between the media item modes, from a ‘view mode’ 113 which includes a representation of the media item to a ‘play mode’ 115 which includes presenting a playable content, related, for example, to the media item 114 or vice versa as provided, in accordance with embodiments, is configured automatically without any need from the user 110 or the computing device 100 to perform any additional action or movement such as pressing action, for example, a ‘touch’ or ‘press’ action on the computing device screen or computing device buttons.

There are provided device, system and method enabling an automatic change from ‘passive’ mode where the media items are only displayed and viewed (e.g. ‘view mode’) by the user to ‘active’ (e.g. ‘play’ mode), or vice versa, where the computer games are playable by detecting movement of for example the computing device 110 or user, identified by one or more sensors, as described herein above and below, in accordance with embodiment.

Respectively, in accordance with embodiments, the user 110 may reconvert the mode or state of the computer game 112 and change it back from a ‘play mode’ to a ‘view mode’ by moving the position of the device 100, for example by rotating the device from a ‘landscape mode’ shown in FIG. 1B back to a portrait mode shown in FIG. 1A.

For example, as shown in FIG. 1C the device 100 may be rotated from state II where the device 100 is in ‘play mode’ to state I where the device will automatically switch its mode to ‘view mode’.

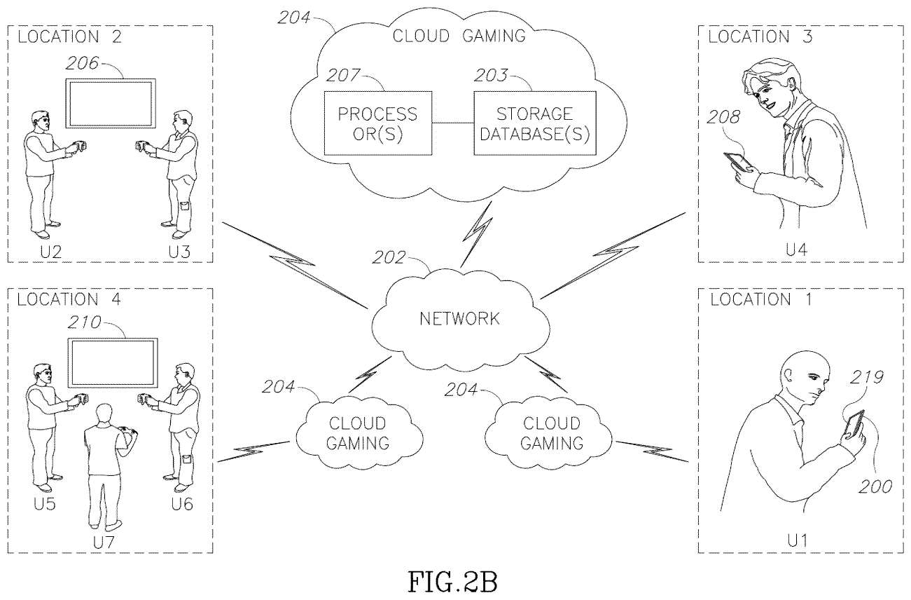

In some embodiments, the one or more computer games are launched before or during the transition from ‘view mode’ to ‘play mode’ for example using streaming techniques as will be explained in details herein below with respect to FIGS. 2A and 2B.

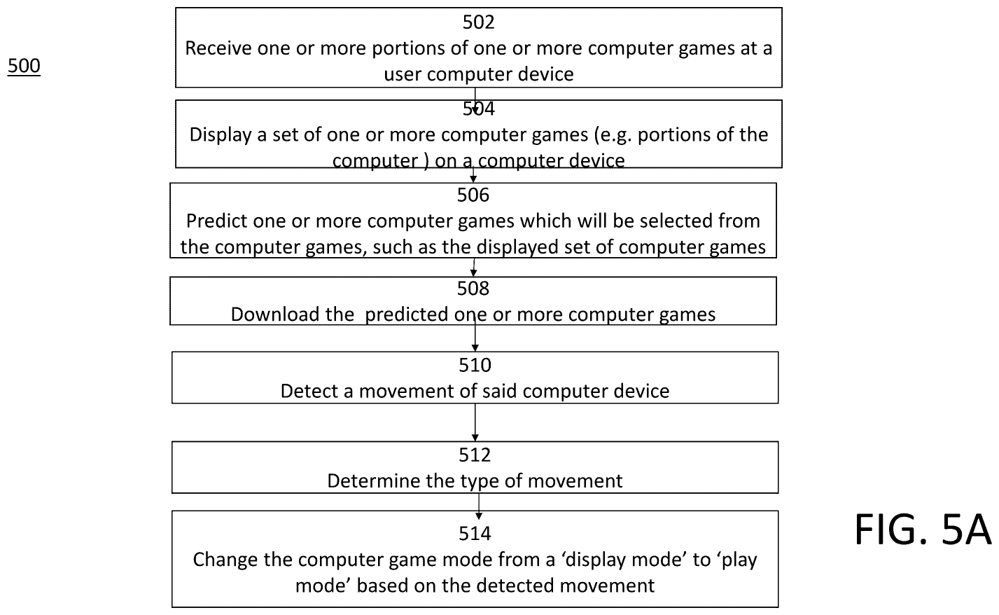

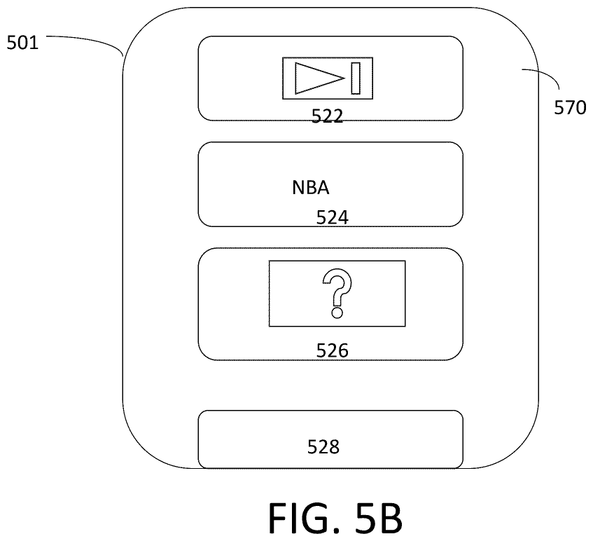

FIG. 1D shows a computing device such as a handheld computing device 107 (e.g. smart phone) including one or more displayed media items, for example a single media item 109 including presentation, such as graphical presentations of an NBA computer game, or any presentations as shown for example in FIGS. 1A-1B or FIG. 5B. The media items are in accordance with embodiments displayed in a ‘view mode’.

In accordance with embodiments of the present invention, the computing device 107 is configured and enabled to recognize one or more movements such as one or more gestures applied on the computing device 107 and to change the mode of the computing device mode and/or control one or more aspects of one or more displayed media items such media item 109 based on the detected one or more gestures.

In one embodiment, the computing device comprises a touchscreen display 111 configured to detect various types of user gestures. The gesture detection system may categorize these gestures into primary categories as follows:

### Single-Point Contact Gestures

The system detects and processes single-point contact gestures wherein a user's single digit contacts the touchscreen display. These gestures include for example:
(a) a “tap” gesture, characterized by a momentary contact between the user's digit and a specific location or one or more locations on the computing device such as the back, front (e.g. touchscreen display 111) or the sides of the computing device, wherein the contact duration is less than a predetermined threshold, for example 500 millisecond. In some embodiments, the “tap” gesture may include one or more taps, such as double taps or triple taps. For example, a double tap may be defined as two consecutive taps on the computing device performed one after the other, within a predetermined threshold for example 500 millisecond.
(b) a “long press” gesture, characterized by an extended contact between the user's digit and a specific location on the touchscreen display, wherein the contact duration exceeds the predetermined threshold; and
(c) a “swipe” gesture, characterized by a continuous contact between the user's digit and the touchscreen display while the point of contact moves along a substantially linear path.

### Multi-Point Contact Gestures

The system further detects and processes multi-point contact gestures involving simultaneous contact of two or more digits with the touchscreen display. These gestures include:
(a) a “pinch” gesture, characterized by simultaneous contact of two digits moving either toward each other (“pinch-in”) or away from each other (“pinch-out”) while maintaining contact with the touchscreen display;
(b) a “rotation” gesture, characterized by simultaneous contact of two digits moving in a substantially circular path while maintaining contact with the touchscreen display; and
(c) multi-finger swipe gestures, characterized by simultaneous contact of three or more digits moving in a substantially linear path while maintaining contact with the touchscreen display.

### Edge-Initiated Gestures

The system additionally detects and processes edge-initiated gestures that begin at or near the for example peripheral edges of the touchscreen display, including:
(a) an “edge swipe” gesture, characterized by a continuous contact beginning within a predetermined distance from the display edge, preferably within 5-10 millimeters of the edge; and
(b) an “edge swipe and hold” gesture, characterized by an edge swipe gesture wherein the contact is maintained at the terminal position for a duration exceeding a predetermined threshold.

### Motion-Based Gestures

The system further comprises motion sensors configured to detect device movement and orientation, enabling the processing of motion-based gestures including:
(a) a “shake” gesture, characterized by rapid oscillatory movement of the device along one or more axes;
(b) a “flip” gesture, characterized by rotation of the device such that the touchscreen display faces downward as illustrated herein above; and
(c) a “raise” gesture, characterized by upward movement of the device from a resting position to a viewing position.

In various embodiments, the gesture recognition system employs a combination of capacitive sensing elements, accelerometers, gyroscopes, and other sensors to detect and measure the characteristics of these gestures. The system processes the sensor data using one or more processors, such as processors 356, executing instructions stored in memory to classify the detected gestures and trigger corresponding actions within the device's operating system or applications.

The gesture recognition system may be configured to recognize variations in gesture characteristics, including but not limited to: contact pressure, contact area, gesture speed, gesture direction, and gesture duration. These variations may be used to trigger different responses or modify the magnitude of the system's response to the gesture.

In accordance with systems and methods of the invention, in response to the user's gestures on the computing device 100 such as swipe movement 117, for example a vertical or a horizontal swipe which includes for example movement of the user finger on the touchscreen display 111, the mode of the media item 109 is switched from a ‘view mode’ to a ‘play mode’ and a user may immediately play a computer game related or not related to the media item 109. The switch between the media item modes, from a ‘view mode’ which includes a representation of the media item to a ‘play mode’ which includes presenting a playable content of the media item or vice versa as provided, in accordance with embodiments, is configured automatically without any need from the user 110 or the device 100 to perform any additional action or movement such as pressing action, for example, a ‘touch’ or ‘press’ action on the computing device screen or computing device buttons. In accordance with embodiments, the change from ‘passive’ mode (e.g. ‘view mode’) where the media items are only displayed and viewed by the user to ‘active’ mode are switched by detecting the gesture movement 117 of the user hand or finger, identified for example by one or more sensors, as described herein above.

Embodiments in accordance with the present invention enables a user to hold for example a computing device, such as computing device 100, in a horizontal position, while viewing and scrolling on a list of media items displayed on the screen of his computing device, and naturally once he identifies a media item which for example relates to a computer game he wishes to play, he may tap once or twice on the computing device and immediately (e.g. less than few milliseconds), one or more sensors of the computing device will detect the tap type and accordingly an operating system, such as an operating of his computing device, will change the present mode from ‘view mode’ to a ‘play mode’ and the user may immediately play the computer game he selected.

FIG. 1E shows another example of automatically transitioning the mode of one or more computer games from a ‘view mode’ to ‘play mode’ or vice versa based on the detected one or more movement types, such as a rotation of a computing device or gestures, such as swipe gesture on the displayed media items. Display Screen 121 includes displaying a list of media items, such as media items MI-V-1, MI-V-2, MI-V-3. These media items are presented in view mode and typically are not playable. In this view mode, the media items are presented in a first layer where the content relating to the media items is typically only viewable. The viewer can only view these media items and swipe for example up or down (e.g. in a portrait mode) and left or write (e.g. in a landscape mode). A movement, such as a right swipe on any of the selected media items changes the state of the selected media item, from a view mode layer, to a playable layer where for example a computer game related to the selected media item is launched and may be played. For example, swipe 123 on media item MI-V-1 displayed on display screen 121 transitions the media item MI-V-1 to a playable computer game mode CG-P-1 as displayed on display screen 125.

Advantageously, the methods and systems of the present invention offer a user-friendly interface experience that allows computer game users to effortlessly and smoothly switch between different modes, such as transitioning from a ‘view mode’ (e.g., mode) to a ‘play mode’ and vice versa. Furthermore, the invention provides the additional advantages of: reducing user interaction complexity by eliminating the need for multiple button presses or menu navigation; enabling immediate gameplay without waiting for downloads through, for example, predictive pre-loading of games; enhancing the natural gaming experience through intuitive device orientation controls; facilitating seamless transitions between browsing and playing states; and improving accessibility by supporting various game types including cloud-based games, streamed content, and locally stored games.

The transition from ‘view mode’ to ‘play mode’ involves movement between different layers. The ‘view mode’ provides a first ‘passive’ layer that mainly presents content to the user, while the automatic switch to ‘play mode’ includes transitioning to a deeper second layer which includes in accordance with embodiments a ‘playable’ layer or an ‘active’ layer where the user plays the content of the computer game.

For example, as shown in FIG. 1D, the swipe from left to right on media item 109 automatically changes the mode of the display and a computer game, such as an NBA computer game, related to media item 109 and the user may immediately may be played by the user.

In accordance with embodiments, the system initiates and activates one or more technological actions when or before a media item is displayed and as a result of a movement (e.g. rotation or gesture) the mode is changed from ‘view’ to ‘play’ or vice versa. The technological actions include for example invoking/launching the computer game, before and/or during the movement by for example opening the game file(s) (e.g. loading the files, executing the game files, rendering the game frames and displaying them to the user), whether on the user's device or on a Cloud Gaming Server. For example, the computer game may be launched before any movement is detected, for example in case the user scrolls for more information on the computer game. In some embodiments, these actions occur after the movement step is performed but can also happen as a result of a prediction program as illustrated herein below, and then the UI will switch from displaying the media items to displaying the rendered frames of the game's program.

FIG. 2A and FIG. 2B illustrates various options and system architectures for downloading, streaming and playing computer games such as computer game 112 of FIG. 1A and FIG. 1B, in accordance with embodiments, for enabling immediate playing of the computer games.

FIG. 2A illustrates a user U1 playing a computer game, in accordance with embodiments of the invention. As shown, the user U1 plays a computer game such as a cloud-based computer game or a downloaded computer game(s) shown on display such as a screen display 219 of his computing device 200 (e.g. handheld computing device), in accordance with embodiments. A cloud-based computer game is a computer game that is primarily executed on a remote server, or that is alternatively executed on the user's device 200, wherein the server contains all of the game files, objects and execution files, such that the server renders the game frames and streams them to the user's client device (e.g. computing device 200). A server, in one embodiment, can include individual servers or servers that may be executed in a virtual machine data center, where many servers can be virtualized to provide the requested processing. A downloaded computer game may be stored in one or more storage databases, such as local or external storage database(s) 203. In the illustrated embodiment, cloud gaming server(s) 204 executes and renders one or more computer games, such as the computer games 112, streaming the rendered frames to the computing device 200 for display on display 219. Additionally, computer games stored on storage database(s) 203 can be downloaded to the computing device 200 for local execution and rendering on the display 219. In some embodiments, computing device 200 is situated at the user's location to receive and process inputs and communicate these inputs to the cloud gaming servers 204, and to receive data (video, audio, graphics, text, assets, files etc.) from the cloud gaming servers 204 and/or from the storage database(s) 203. In accordance with embodiments, the user U1 and the cloud gaming servers 204 may communicate over a network 202, such as the Internet.

In some embodiments, the computing device 200 can be any device, whether portable such as device 100 of FIG. 1A and FIG. 1B or not, whether wireless or not, where the user can communicate with a network and provide access to a display for rendering game play and enable input from the user to drive interactivity. In one embodiment the computing device 200 is connected or in communication with storage database(s) 203 and not connected to the network 202. In one embodiment, the computing device 200 is a thin client. However, in other embodiments, the computing device 200 can be a general purpose computer, a special purpose computer, a gaming console, a personal computer, a laptop computer, a tablet computer, a mobile computing device, a portable gaming device, a portable device comprising display screen which is configured to render graphics, a handheld computing device, a cellular phone, a set-top box, a streaming media interface/device, a smart television or networked display, a smart watch, or any other computing device capable of being configured to fulfill the functionality of a computing device 200 as defined herein.

In one embodiment, the cloud gaming server 204 is configured to detect the type of computing device 200 which is being utilized by the user, and provide a cloud-gaming experience appropriate to the user's computing device 200, including adjusting the rendering quality, frame rate, and streaming parameters based on the device's display capabilities and network conditions. For example, image settings, audio settings, display settings and other types of settings may be optimized for the user's client device.

In various embodiments, the degree of processing performed by the computing device 200 may vary with respect to input and output processing. For cloud-based games, the computer game state is maintained, executed, and rendered on the cloud gaming server(s) 204, with the computing device 200 functioning primarily to: (1) receive and communicate user inputs to the servers, and (2) receive and display the rendered frames streamed from the servers. For downloaded games from computer game storage(s) 203, the computing device 200 maintains game state, executes the game, and performs the rendering locally for display on display 219. The computing device 200 may be a standalone device that renders computer data and outputs the rendered content to the connected display 219. In one embodiment, the display 219 is a networked display that provides a platform operating system for applications or “apps” utilizing network connectivity. In such an embodiment, the computing device 200 can be implemented as an application executed on the platform provided by the display's operating system.

FIG. 2B illustrates multiple users in multiple locations engaged in gameplay of cloud-based computer games and/or downloaded computer games. The user U1 is shown at a first location (location 1) interacting with a computer game rendered on the display 219. Users U2 and U3 are shown at a second location (location 2) interacting with a computer game rendered on a display 206. A user U4 is shown at a third location (location 3) playing a computer game rendered on a display 208. Users U5, U6, and U7 are shown at a fourth location (location 4) interacting with a computer game rendered on a display 210.

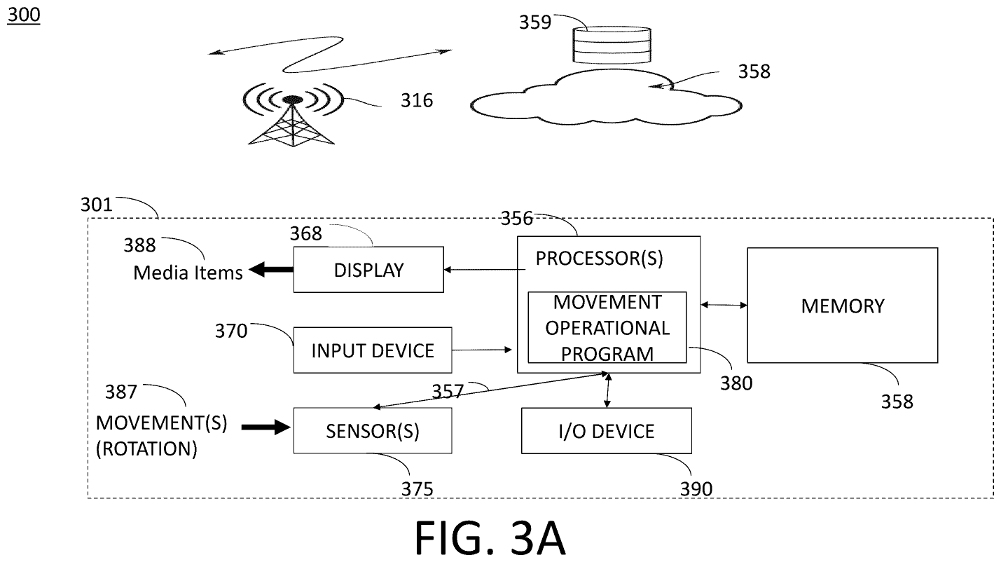

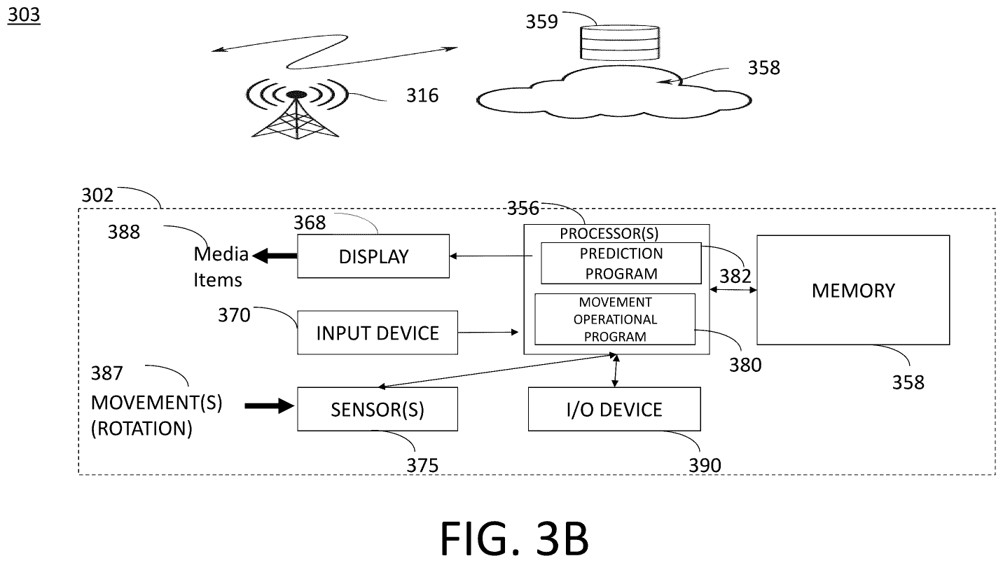

At each of the first, second, third, and fourth locations, at least one computing device is provided for: (1) processing input from the various users and transmitting it to the cloud gaming servers, and (2) receiving rendered frames of cloud-based computer games from the cloud gaming servers and/or rendering downloaded computer games on their respective displays. For cloud-based games, the game execution and rendering occur on the remote cloud gaming servers, which then stream the rendered frames to the local computing devices for display. For downloaded games, the local computing devices perform both the processing and rendering functions. It should be appreciated that the computing device can be integrated into a display, or may be a standalone device such as a personal computer, set top box, gaming console, mobile device such as a mobile phone for example handheld computing device 100 or any other type of device having at least one processor and memory for processing and storing data. The computing device can execute or define a client, as has been described above in FIG. 1A, FIG. 1B, FIG. 1C, FIG. 1D and FIG. 1E and below in FIG. 3A. The computing devices may be networked, and may communicate over a network, such as the internet 202, with cloud gaming servers 204 and/or computer with storage database(s) 203.

The cloud gaming servers 204 execute and render the various cloud-based computer games which are being played by the users, defining a given computer game's game state from moment to moment, performing the graphics rendering, and streaming the rendered frames along with audio data to the computing device 200 at a particular location. The computing device 200 at a given location processes input from the user(s) playing the computer game, and transmits input data to the cloud gaming server, which in turn processes the input data to affect the game state of the computer game. It should be appreciated that cloud-based gaming facilitates multi-user gaming from users located at different locations by providing for the execution of the computer game at a remote server that is accessible by all users over a network. In accordance with some embodiments, in the cloud gaming servers 204 manner, execution of the computer game is not dependent on any single user's hardware or network conductivity, though such will affect the user experience for that given user.

In some embodiments, multiple users, either dispersed across various locations or located within a single venue, partake in the interactive gaming experience facilitated by the direct retrieval of computer games. This process involves the utilization of local or external computer game storage, exemplified by the storage database(s) 203, for the purpose of downloading computer games.

The combination of a cloud gaming platform as illustrated in FIG. 2A and FIG. 2B and the process of transitioning from ‘view mode’ to ‘play mode’ based on identifying one or more movements, enables a user to immediately, in less than a few milliseconds, play a computer game, without any need to press and wait for the complete computer game to be downloaded, by streaming the computer game from a Cloud Gaming Server. This seamless transition is achieved through advanced streaming technology that minimizes latency between the server and client device, with the server handling all intensive processing and rendering tasks while the client device primarily manages user input and display output. The system dynamically adjusts streaming quality based on network conditions and device capabilities, ensuring optimal performance across various connection speeds and hardware configurations. Real-time encoding and compression techniques help maintain visual fidelity while reducing bandwidth requirements, making the platform accessible even on networks with moderate speeds. The elimination of traditional download and installation processes significantly reduces the barrier to play computer games that they haven't already installed on their device, allowing users to instantly sample different titles through natural device movements rather than navigating complex menus or waiting through lengthy downloads.

FIG. 3A is a block diagram of an exemplary computing system 300, in accordance with one embodiment of the present invention. The computing system 300 comprises a computing device 301, such as a laptop, tablet or handheld computer. The computing device 300 may also correspond to a computing device, such as a cell phone, PDA (Personal Digital Assistant), dedicated media user, consumer electronic device. In some cases, the computing device 301 may be the handheld computing device 100 shown in FIGS. 1A-1C.

The exemplary computing device 301 shown in FIG. 3A includes one or more processors 356 configured to execute instructions and to carry out operations associated with the computing system 300. For example, using instructions retrieved for example from memory subsystem 358 or external memory subsystem 359, the processor 356 may control the reception and manipulation of input and output data between components of the computing system 300. The one or more processors 356 can be implemented on a single-chip, multiple chips or multiple electrical components. For example, various architectures can be used for the processors 356, including dedicated or embedded processor(s), single purpose processor, controller, ASIC, and the like.

In many cases, the one or more processors 356 together with an operating system operates to execute computer code and produce and use data to generate/play for example a computer game, and mostly contains a Graphical Processing Unit (GPU). The operating system can also be a special purpose operating system, such as may be used for limited purpose appliance-type computing devices. The operating system, other computer code and data may reside within the memory subsystem 358 that is operatively coupled to the processor 356 or the external memory subsystem 359. Memory subsystem 358 generally provides a place to store computer code and data that are used by the computing system 300. By way of example, the memory subsystem 358 may include Read-Only Memory (ROM), Random-Access Memory (RAM), and/or the like. The information could also reside on a removable storage medium and be loaded or installed onto the computing system 300 when needed.

In some embodiments, the Memory Subsystem 358 may incorporate or be linked to the external memory subsystem 359 such as a cloud-based storage system designed for computer games, configured and enabled for the downloading, receiving, and storage of one or more computer games. The downloading of computer games may occur through various options, including servers such as cloud gaming servers and other available alternatives illustrated in FIG. 2A and FIG. 2B.

In some embodiments, the relationship between Memory Subsystem 358 and external memory subsystem 359 enables flexible and efficient data management. The Memory Subsystem 358 serves as primary, local storage for immediate access requirements, while the external memory subsystem 359 functions as expandable storage with configurable connectivity options. Both systems can operate independently or in synchronized mode according to system requirements and user preferences. Data synchronization between these systems occurs based on configurable parameters that consider network availability, storage capacity, and access patterns. This dual-storage architecture enables optimal performance across varying network conditions and usage scenarios while maintaining data consistency and availability.

In some embodiments computing system 300 may be in wireless communication 316 with the external memory subsystem 359.

The computing device 301 may also include a display device 368 that is operatively coupled to the processor 356. The display device 368 may be for example a liquid crystal display (LCD) (e.g., active matrix, passive matrix and the like). Alternatively, the display device 368 may be a monitor such as a monochrome display, color graphics adapter (CGA) display, variable-graphics-array (VGA) display, super VGA display, cathode ray tube (CRT), and the like.

The display device 368 is generally configured to display one or more media items 388. In general, media items 388 may refer for example to graphical representations, which may encompass the visual elements and graphics found in computer games.

The computing device 301 may also include an input device 370 that is operatively coupled to the one or more processors 356. The input device 370 may also be used to issue commands in the computing system 300. The input device 370 may include a touch-sensing device configured to receive input from a user's touch and to send this information to the processor 356. The input device 370 may be a touch screen that is positioned over or in front of the display 368. The input device 370 may be integrated with the display device 368 or it may be a separate component.

In accordance with embodiments, computing device 301 comprises one or more sensors 375 that are operatively coupled to or in communication with the one or more processors 356 and the display device 368. The sensors 375 are configured and enabled to identify any movement such as rotation movement of the system 300 and operate an action on the display device 368 once such rotation or movement or gesture is detected. For example, sensors 375 may include, but are not limited to, one or more of the following types of devices: a gyroscope, an accelerometer, a magnetometer, or any other type of sensor capable of detecting, measuring, or determining the orientation, motion, acceleration, angular velocity, or movement of the device 301 or any element in system 300. These sensors 375 may operate independently or in combination to provide enhanced data regarding the dynamic state or positioning of the device 301. Furthermore, sensors 375 may include additional components, such as inclinometers, inertial measurement units (IMUs), or other devices configured to capture and process spatial and kinematic parameters.

In accordance with embodiments, the one or more processors 356 may be configured to receive data signal(s) 357 from the sensors 375. These data signal(s) 357 may include or may be one or more movement signals that include information about the motion, orientation, or movement characteristics of the device 301 or the user movement (e.g. gesture).

In accordance with embodiments, the data 357 is transmitted to the one or more processors 356 to analyze the movement information using, for example, a movement operational program 380 and identify the movement type (e.g. rotation, gesture type, rotation direction, rotation angle, rotation speed, etc.), and based on the identified movement type the one or more processors 356 transition the displayed ‘view mode’ of the media items 388 to ‘play mode’ of computer games (e.g. which may relate directly or indirectly to the media items) or vice versa.

In some embodiments, the movement information comprises a threshold such as a predefined threshold of the rotation angle and/or movement of the device 301 or the display 368. In some cases, if the rotation angle exceeds the threshold, the movement operational program 380 sends a command to processors 356 to rotate the screen of the display device to match the orientation of the device 301 and/or display 368 and additionally, for example, simultaneously, activate the computer game (e.g. triggers “play mode”) so the user may play the displayed computer game.

In some embodiments, the one or more processors 356 may include the movement operational program 380, which may be part of an operating system or a separate application. The movement operational program 380 generally includes a set of instructions that recognizes the occurrence of movement 387 and informs the processors 356 of the movement 387 and/or what action(s) to take in response to the detected movement 387 or to the sequence of more than one movement 387.

By way of example, device 301 may be a mobile phone and the sensors 375 may detect, for example in real-time, the movement 387 (e.g. rotation movement) of the mobile phone (e.g. detect the rotation angle of the mobile phone) or gesture of a user and provide movement signals (e.g. comprising the movement information included in data 357) to the one or more processors 356.

In accordance with embodiments, during operation, the user can view (e.g. in a view mode) various categories of different media items 388, such as highlights of one or more gameplays of the computer games, GPH, minigames, demos and the like. The sensors 375 detect the movement 387 of the mobile phone (e.g. by using movement operational program 380), such as a rotation movement of the mobile phone by 90 degrees. This movement changes automatically the mode of the media items 388 displayed on the handheld device to play mode of computer games, facilitating an optimal and natural gaming experience.

In accordance with embodiments, while movement 387 (e.g. rotation) can be done with one or two hands, it's usually initiated with one hand holding and rotating the system as shown in FIG. 1A. The user can then transition to two hands for better control, as illustrated in FIG. 1B, or use only one hand. In all of these cases, the one or more processors 356 receives the rotation/movement 387 or sequence of more than one movement 387 and the processor 356 executes instructions on a displayed computer game to carry out operations associated with the movement 387 or sequence of more than one movement 387. In all of these cases, the processor 356 may use the movement operational program 380 to detect the rotation angle.

In some embodiments, the one or more processors 356 may also adjust the size and position of the image on the screen (e.g. display) to fit the rotated screen. For example, simultaneously, once the ‘play mode’ is triggered when the rotation/movement 387 is detected, the one or more processors 356 send a command to display 368 to manifest the play mode, e.g. to run the game, put an objective screen of the computer game (e.g. PGH), and the like.

In some embodiments, the sensors 375 are coupled or in communication with the input device 370 and the one or more processors 356.

In some embodiments, the computing device 301 also includes capabilities for coupling to one or more I/O (Input/Output) devices 390. By way of example, the I/O devices 390 may correspond to keyboards, mouse, joystick, mobile phone, tablet, smart watch and/or the like. The I/O devices 390 may be integrated with the computing device 301 or they may be separate components (e.g., peripheral devices). In some cases, the I/O devices 390 may be connected to the computing device 301 through wired connections (e.g., cables/ports). In other cases, the I/O device(s) 390 may be connected to the computing device 301 through wireless connections. By way of example, the data link may correspond to PS/2, USB, IR, RF, Bluetooth or the like.

In some embodiments, a method and system for processing movements inputs such as touch-based gestural inputs on the computing device may include: a sensor such as a capacitive touchscreen sensor array that generates electrical signals corresponding to user contact points; an analog-to-digital converter that transforms the analog sensor signals into digital coordinate data; a dedicated touch controller chip that performs initial signal processing and touch point detection; a main system processor such as processors 356 executing gesture/movement recognition software that receives the preprocessed touch data through a hardware interrupt; wherein the processors analyzes temporal sequences of touch coordinates while managing device resources including CPU cycles, memory access, and power consumption through the device's power management unit.

The processor may implement digital signal processing algorithms to filter the coordinate data, calculates movement vectors, and compares detected patterns against gesture templates stored in the device's flash memory; upon validation of a movement such as swipe gesture, the processor triggers the graphics processing unit to render for example corresponding visual feedback through the display controller while simultaneously notifying the operating system scheduler to execute and trigger a computer game related to the media item which was swiped. In some embodiments the operations being coordinated through the device's system bus and managed by the operating system kernel to ensure real-time gesture response while maintaining overall system performance and power efficiency.

FIG. 3B is a block diagram of an exemplary computing system 303 comprising a device 302 and a prediction module 382, in accordance with some embodiments of the present disclosure.

FIG. 3B comprises all the elements illustrated in FIG. 3A and further comprises the prediction program 382 which is configured and enabled to predict which media items such as media items 388 of computer games will be selected and played by the user, using the prediction methods described herein above, and send a command to the processor 356 to download the predicted computer game. The prediction program may operate continuously in the background, analyzing user behavior patterns, historical game selection data, current user session data, game popularity metrics, user preferences, and contextual data to ensure accurate predictions.

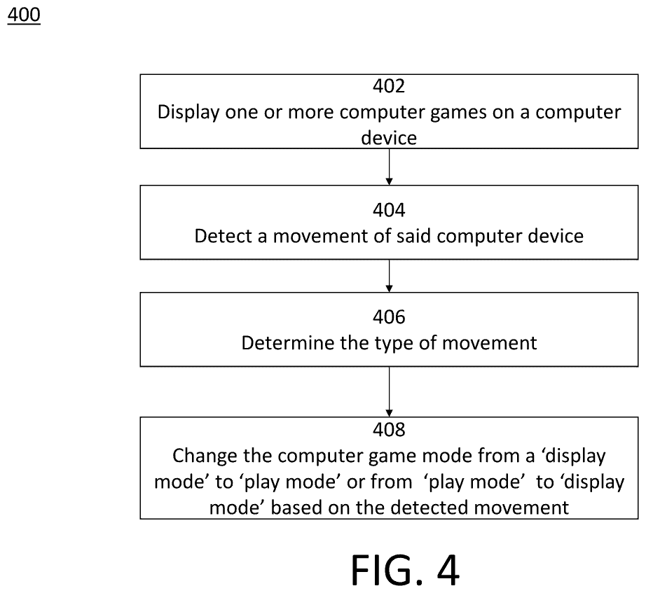

FIG. 4 illustrates a flowchart of method 400 for automatically switching/transitioning the mode of one or more media items such as media items (e.g. related to computer games) displayed on a computing device from a ‘view mode’ to ‘play mode’ based on a detected movement of the computing device or the user, in accordance with one embodiment of the present invention. For example, method 400 includes automatically launching a computer game of a displayed media items on the user's device before and once or following the user rotation of the device. The handheld device 100 or computing devices 301 or 302, for example, may be used to implement method 400. However, method 400 may also be implemented by systems or devices having other configurations. Typically, the computing device is a sensitive handheld mobile system, such as a mobile phone comprising one or more sensors for detecting the movement of the computing device.

At step 402, one or more media items, such media items related directly or indirectly to computer games, are displayed on the display (e.g. screen) of the computing device. In some cases, the displayed media items comprise a presentation of one or more images or computer clips, such as highlights, or demos associated with a set of computer games. In some cases, the displayed game may comprise specific segments thereof, a demonstration of the game. As an example, according to some embodiments a graphical indication 116 ‘play’ sign, as illustrated in FIG. 1A, notifies a user that the displayed image or media item is related to a computer game that may require further action to be played. Accordingly, presenting the graphical indication 116 of the media item can prompt the user to interact with the computing device. The graphical indication 116 is displayed in a user interface 135. In some embodiments, the user interface 135 may be the portion of a screen 170 such as a touchscreen that may be controlled by a particular application program and that receives information from a particular third-party application to generate the user interface 135 (e.g., a web browser or third-party application program that is downloaded from an application marketplace).

According to some embodiments, the graphical indication 116 comprises a dynamic interface element that provides comprehensive visual feedback about game state and availability. The indication adapts its appearance based on the current mode, transitioning between ‘view mode’ and ‘play mode’ while indicating loading status and game readiness. The indication may include interactive elements for direct user manipulation, enhancing the user experience through clear visual communication of system state and available actions. The user interface 135 integrates with screen 170 through a display architecture that enables simultaneous presentation of game content and interface elements. This integration supports configurable layout adaptation based on screen orientation, with dynamic scaling of interface elements based on screen properties. The interface presents controls and indicators contextually, ensuring relevant information and interaction options are available to the user at appropriate times based on the current system state and user actions.

In an exemplary embodiment, the third-party application program may comprise a computer gaming application, including but not limited to, the Android Computer Gaming Store, Apple Gaming Store, and other recognized computer game download stores such as the Microsoft Xbox™ app, Playstation Store™, among others.

According to some embodiments, users of the third-party downloaded application can download and access the computer games in one or more of the following methods:
a. Accessing or presenting a computer game previously downloaded onto a computing device (e.g., computing device 100, 301 or 302). In accordance with this embodiment, the computer game may be downloaded into the user's computing device, for instance, from an external storage medium such as Memory Subsystem 358. This downloading can occur explicitly through user-initiated actions, such as clicking a “Download” button, or alternatively, the computer game can be procured via a server, as depicted in FIG. 2A and FIG. 2B.
b. Receiving one or more computer games through various streaming techniques. For instance, users can opt to employ a Cloud Gaming Streaming service to stream the game, as exemplified in FIG. 2A and FIG. 2B.
c. Accessing or presenting the computer game using a hybrid approach which combines the above options a. and b., e.g., downloading directly the computer game to the user's device and streaming some computer games via one or more servers to the device. According to the “Hybrid” approach, some parts of the game can be accessed via streaming techniques while the rest of it is already downloaded into the user's device, such that some parts of the game are being played from the downloaded files and others are streamed. For example, for a computer game that contains 2 levels, all the required file games for playing the 1st level of the game (including for executable files, graphic files, gaming asset files, sounds and other file types) can be downloaded into the user's device, excluding the rest of the files that are only needed for playing the 2nd level (e.g. graphic files that are only relevant for the 2nd level). In this example, the 1st level of the game can be played directly from the files that were downloaded, while the relevant files that are needed to play the 2nd level could be streamed to the user's device, or alternatively be played using a Cloud Gaming Streaming service.

According to some embodiments, the computer games are directly/indirectly downloaded from a storage device, like a computer game storage) e.g. storage database(s) 203 or Memory subsystem 359, without the need for a dedicated app.

Following step 402, method 400 proceeds to step 404 where a movement or movements of the computing device or the user (e.g. user's finger) is detected. In some cases, the movement(s) of the device or the screen (e.g. display) or both is detected using one or more sensors of the computing device as illustrated in FIG. 3A and FIG. 3B.

In some embodiments, the potential movements and rotations include: a rotation of 90/270 degrees from a vertical to a horizontal position or vice versa, as well as any form of transition from a vertical to a horizontal orientation of the computing device. According to one embodiment, the movement may be a rotation movement of the computing device. Specifically, the rotation movement may be a rotation movement relative to a reference point, for example, a rotation from a present vertical position of the device, with respect to a cartesian axis, known as a ‘portrait mode’ to a horizontal state with respect to a cartesian axis known as a ‘landscape mode’ as shown in FIG. 1A, FIG. 1B and FIG. 1C.

In some embodiments, the movement may include any combination of clockwise rotations, counterclockwise rotations, or gestures as illustrated in FIG. 1C.

Following step 404, method 400 proceeds to step 406 where the type of movement of the device or user is detected and determined, using for example processor(s) as shown in FIGS. 3A-3B. In some embodiments, the type of movements is determined by the processors which receive one or more signals such as movement signals from the one or more sensors. The processors further process the one or more movement signals to yield the one or more movement types, such as detecting a rotation movement, gesture (and the like) and the direction of the movement.

Following step 406, method 400 proceeds to step 408 where one of the computer games presented on the display is launched based on the identified movement type. In accordance with embodiments, once a movement is identified (e.g. rotation or gesture) the mode of the computer device are automatically transitioned from a ‘view mode’ to ‘play mode’ (or vice versa) based on the identified one or more movement types.

Specifically, the displayed computer game mode is changed (e.g. transitioned) to a different mode based on the detected or determined movement type, in accordance with embodiments. More Specifically, a computer game state is switched or changed from a ‘view mode’ where the user can only view the computer game(s) to a ‘play mode’ where the computer game(s) may be actively played (or vice versa) based on an identification of the movement of the computing device, for example, identification of the rotation of the computing device that passes a predefined threshold or predefined state or identifying a swipe gesture. As a result, the user can start playing the computer game displayed on the screen without waiting for the computer game to be downloaded, thereby enhancing the user experience.

In accordance with embodiments, as shown in FIG. 5B when multiple media items, such as media items 522, 524, 526 and 528, are simultaneously displayed on the display of the computing device 501. The media items may include various representations of computer games. For example, media item simply includes a graphical icon such as a ‘play icon’, media item 524 includes graphical representation of an NBA game, and media item 526 includes a ‘question’ mark which may be linked directly or indirectly to a computer game, such as an PGH or mini game, in accordance with embodiments.

In accordance with embodiments, during the movement of the computing device 501 (or before or after the movement), the selected computer game related to the media item to be automatically transitioned from a ‘view mode’ to ‘play mode’ will be the one covering more than 50% of the display. For instance, a media item whose pixels constitute more than 50% of the screen pixels (e.g. display pixels) of the moved device. If two media items equally occupy the screen (e.g., 50% pixels each for both computer games, for example media items 522 and 524), the computer game related to the media item displayed at the bottom of the screen will automatically transitioned from a ‘view mode’ to ‘play mode’. It is emphasized that alternative rules for selecting the displayed computer game may be specified based on the preferences of the computer game user or the computer game provider.

In some embodiments, the system uses multi-factor analysis to select which game will automatically transitioned from a ‘view mode’ to ‘play mode’ when multiple games are displayed. The selection process evaluates screen coverage percentage, with games occupying more than 50% of the display area receiving primary consideration. When multiple games share similar screen coverage, the system considers additional factors including active user interaction zones, content visibility state, and vertical or horizontal positioning on the screen. In cases where multiple games meet primary selection criteria, the system evaluates secondary factors such as recent interaction history, loading state completion percentage, and user preference alignment. The selection mechanism incorporates time-based considerations, giving priority to games displayed earlier in the session while accounting for game state preservation requirements. This logic ensures consistent and predictable game selection behavior while maintaining optimal user experience through intelligent content prioritization.

Specifically, the methods and systems in accordance with embodiments include calculating, for example using processors 356 and/or Movement operational program 380, which computer game (e.g. PGH or minigame) relatively takes most of the screen size by calculating for example the size (e.g. in pixels) of each displayed computer game and selecting the largest (e.g. in pixels) computer game. In cases where two or more computer games have the same image size and/or cover the same relative size in the display screen then the computer game may be selected based on predefined criteria such as a criteria including choosing a computer game displayed on the top of the screen and/or a computer game displayed on the right side of the screen, and the like.

FIG. 5A illustrates a flowchart of a computer game automatic-mode-change and prediction method 500, in accordance with another embodiment of the present invention. Specifically, method 500 comprises predicting which computer game of a set of media items (one or more media items such as media items 522,524, 526 and 528) presented on the user's computing device will be selected by the user and automatically playing the selected computer based on a detected movement of the computing device. For example, method 500 includes automatically predicting and automatically transitioning from a ‘view mode’ to ‘play mode’ (or vice versa) the media item displayed on the user's device when the user rotates the device. For example, computing devices 100, 301, 302 or 501 may be used to implement method 500. However, method 500 may also be implemented by systems or devices having other configurations. Typically, the computing device is a sensitive handheld mobile system, such as a mobile phone comprising one or more sensors for detecting the movement of the computing device as illustrated in FIG. 1 and FIGS. 3A.

At step 502 one or more portions and/or selected or preselected parts of one or more media items are presented at a user's computing device. For example, the presented media items (e.g. media items 522, 524,526 and 528) may be one or more short highlight gameplay moments of one or more computer games. In some cases, these highlight gameplay moments may include brief video clips that may be referred to as ‘trailers’ or ‘previews’ or ‘highlights’ of the computer games or only graphical presentation of the computer games. These brief clips provide a glimpse of the content available on each computer game and can help users decide which computer game to play.

According to some embodiments, the computer games related to the media items (directly or indirectly) may be received using for example a third-party downloaded application which provides access and enables downloading computer games.

According to some embodiments, the computer games may be downloaded and/or received in one or more of the methods illustrated and detailed above with reference to FIG. 2A, FIG. 3A, FIG. 3B FIG. 2B and FIG. 4.

At step 504, the one or more media items are displayed on a display such as display screen 570 of the computing device. In some cases, the displayed computer games comprise a presentation of one or more images and/or video clips and/or text and/or graphics and the like, such as image highlight, associated with the one or more computer games as explained in step 502.

At step 506 one or more media items such as one or more of the displayed one or more media items (e.g. media items 522, 524, 526 and 528) are predicted to be selected from the set of displayed media items and/or played by the user. In accordance with embodiments, the media items are predicted using prediction methods, such as Machine Learning or Artificial Neural Networks. The prediction methods include using Artificial Intelligence (AI) methods such as Logistic Regression, Machine Learning, Graph Machine Learning, Artificial Neural Networks and the like.

At step 508 the predicted one or more computer games (e.g. of the media items) are downloaded partially or completely as described herein above with respect to step 502. In some embodiments, the computing device downloads the predicted computer games in the background as explained in steps 502 and 508, while the user continues browsing and viewing other computer games.

At step 510 a movement of the computing device or the user is detected. In some cases, the movement of the device or the user is detected using one or more sensors of the computing device as illustrated in FIG. 3A and FIG. 3B. It should be understood that the movement may be any movement as described above with reference to the herein above FIGS. 1A-1B.

At step 512 the type of movement of the device is identified. According to one embodiment, the movement may be a rotation movement of the computing device or gesture of the user. Specifically, the rotation movement may be a rotation movement relative to a reference point, for example, a rotation from a present vertical position of the device, with respect to a cartesian axis, known as a ‘portrait state’ to a ‘horizontal state’ with respect to a cartesian axis known as a ‘landscape mode’. In some embodiments, the movements may include a mix of various movements and gestures as mentioned above.

At step 514 the displayed computer game mode is transitioned automatically to a different mode based on the detected movement, in accordance with embodiments. Specifically, a computer game state is switched from a ‘viewing mode’ to a ‘play mode’ (or vice versa) and the computer game which was displayed during the movement detection may be immediately played (e.g. less than 1-10 milliseconds) based on an identification of the movement of the device, or user gesture for example, identification of a rotation of the computing device. In some cases, as a result of a pre-downloading and prediction process of steps 506 and 508, the user can start playing the computer game displayed on the screen without waiting for the computer game to be downloaded, thereby enhancing the user's computer game playing experience.

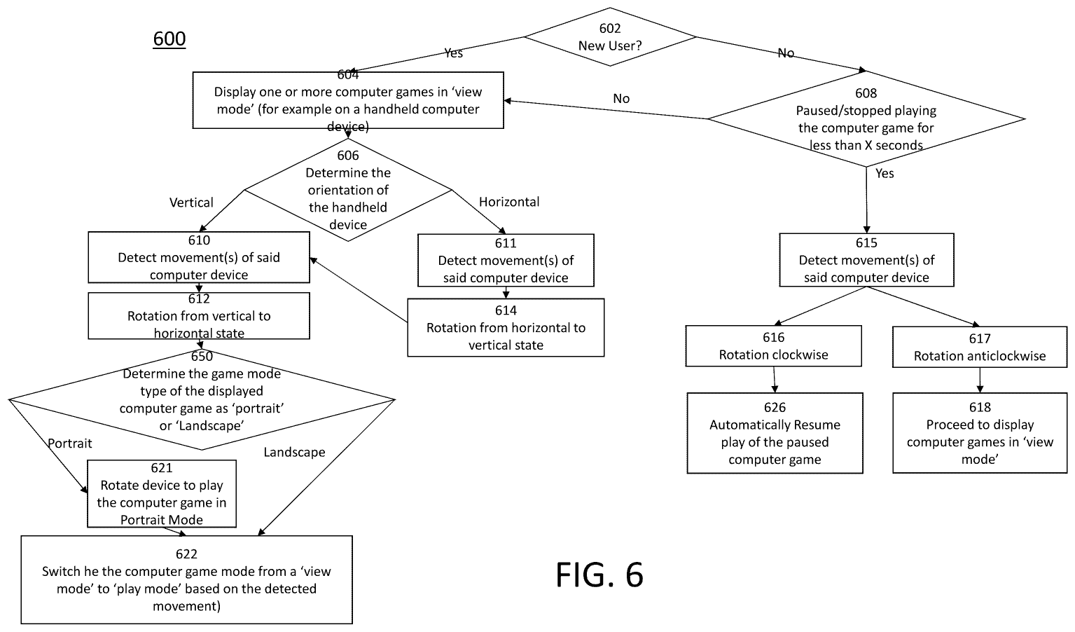

FIG. 6 illustrates a flowchart of a computer game automatic-mode-change method 600, in accordance with another embodiment of the present invention. FIG. 6 specifies various scenarios for triggering (e.g. transitioning from ‘view mode’ to ‘play mode’ and vice versa) the displayed computer game, based on one or more of: the mode of the computer game (portrait/orientation), the present position of the computing device (horizontal and/or vertical) and the identified movement of the computing device. In some cases, computing devices 301, 302 or device 100 may be used to implement method 600. However, method 600 may also be implemented by systems or devices having other configurations. Typically, the computing device is a sensitive handheld computing device, such as a mobile phone comprising one or more sensors for detecting the movement of the computing device as illustrated in FIG. 1A, FIG. 1B FIG. 3A, and FIG. 3B.

The method 600 initiates at decision point 602, wherein a user (e.g., user U1), or multiple users (Users U2, U3 and the like), is/are classified as either a ‘new user’ or an ‘old user’ (e.g., new/old user). A ‘new user’ is elucidated as an entity, which may comprise one or more individuals, that has downloaded for example a media app such as a computer game app or one or more computer games but has not yet participated in playing or selecting any media items for example computer games. Conversely, an ‘old user’ pertains to an entity, for example encompassing multiple individuals, that has commenced using/playing the media item, and paused. For example, commenced gameplay in one or more of the downloaded or displayed computer games but has subsequently paused or stopped playing the computer game.

In the case of a new user, the flow proceeds to step 604 where one or more media items (e.g. computer games) are displayed on the screen of the computing device in ‘view mode’, as shown for example in FIG. 5B. In some cases, the displayed media items (e.g. computer games) comprise a presentation of one or more images and/or video clips and/or text and/or graphics and the like, such as image highlight, associated with a set of the media items (e.g. computer games). In some cases, the displayed computer game may comprise a complete game, specific segments thereof, a demonstration of the game, or a playable gameplay highlight. In some cases, the displayed computer games may be or may include one or more of: highlight gameplay moments, minigame, Playable Gameplay Highlight(s) (PGH), text, image, graphical image of the media item and the like.

Following step 604 the flow proceeds to step 606 including a decision point to determine the orientation of the computing device. For example, the computing device may be a handheld device, and including the step of determining the position in which the user holds the handheld device. In case the device is held in a vertical position as shown in FIG. 1A then at step 610 a movement (e.g. rotation) of the device is detected using one or more sensors as illustrated in FIG. 1A-FIG. 1C and FIG. 3A-FIG. 3B. Once a movement (e.g. rotation) from a vertical to horizontal state is detected at step 612, then the flow proceeds to step 650 including a decision point to determine the game mode type of the displayed computer game as ‘portrait’ or ‘landscape’. In case the game mode type is constant, this parameter can be calculated in advance, or retrieved, for example in advance, for example from the game studio/game developer, or be cached for a later use. In case the displayed media item, for example the computer game is a ‘portrait’ mode computer game type then optionally at step 621 the user will move (e.g. rotate) the device to vertical position to accordingly play the computer game in portrait mode, and at step 622 the computer game which was displayed during the movement of the device is automatically playable, hence, the computer game mode is switched from ‘view mode’ to ‘play mode’ based on the detected movement. In case the computer game mode type is a ‘landscape’ mode computer game then the flow proceeds directly to step 622 as the user may keep holding the device in a horizontal (e.g. landscape as illustrated in FIG. 1B) and the displayed media item (e.g. computer game) is automatically triggered, for example simultaneously, based on the identified movement.

If the handheld device is oriented horizontally at decision point 606, the flow moves to step 611 to detect device movement. At step 614, a rotation from horizontal to vertical position is detected (e.g. and requested), then proceeding to decision point 610 to detect movement(s) of the computer device, and following to step 612 to perform rotation from vertical to horizontal state as shown in FIG. 1B, for triggering the selected media item. It is stressed that while in FIG. 6 the “view mode' is only in cases where the computing device is in vertical state (e.g. portrait mode) and the media items (e.g. the computer games) are triggered while rotating to horizontal state (e.g. landscape mode), other modes and triggering options are possible in other cases. For example, where the “view mode' is only in cases where the computing device is in horizontal state (e.g. landscape mode) and the media items (e.g. the computer games) are triggered while rotating to vertical state (e.g. portrait mode). The various triggering and rotation options may be defined by the user device operating system, by the app provider, or by the user, in accordance with embodiments.

If the computer game user at decision point 604 is not a new user, the flow proceeds to step 608 to determine whether the user paused or stopped playing the computer game for less than a predetermined time—such as less than X seconds/minutes, for example, less than 60 seconds. If the user didn't pause/stopped playing less than the predetermined time the flow proceeds to step 604 as the user is now defined as ‘new user’ and the media item/computer game is displayed in a ‘view mode’.

If the user paused/stopped playing the computer game for less than X seconds (e.g. less than 30 seconds), then the flow proceeds to step 615, (as the user is not a ‘new user’) where the movement(s) of the device is detected. In accordance with embodiments, at step 615 different types of movements or movement directions may switch the display and/or play mode of the computer games. For example, at step 616 if a clockwise rotation of the device is detected, e.g. from a vertical position as shown in FIG. 1A to horizontal position as shown in FIG. 1B, then at step 626 the paused computer game is automatically resumed, while in case for example an anticlockwise rotation is detected, e.g. from a horizontal position as shown in FIG. 1B to vertical position as shown in FIG. 1A, the mode proceeds to ‘view mode’ and the user may scroll and/or browse to view other computer games. In some embodiments, step 615 may present to the user a graphical interface such as a “pause screen” view of the game, PGH, demo, mini-game or game derivative.

It is stressed that, in accordance with embodiments, the user and/or the computer game provider or computer game creator may decide on alternative configuration for triggering a displayed computer game such as a paused computer game. For example, the user may decide that an anticlockwise rotation triggers the paused game and a clockwise rotation switches the computer game to ‘view mode’.

In some embodiments, method 600 may include displaying messages or signs to direct or update the user on the rotation movements that need to be performed to trigger the computer game or pause the computer game. For example, the displayed messages may be a “rotate your screen” sign in the user's screen so the user would rotate the screen for example to vertical state (e.g. portrait mode).

In some embodiments, the system manages transitions between viewing, playing, and paused states through a state machine. For new users, the initial state defaults to viewing mode, while returning users may resume from their last active state if within the configurable time threshold. The transition between states considers the user's interaction history, device orientation, game readiness, and network conditions. Each state transition triggers appropriate resource allocation and deallocation, ensuring optimal performance during mode changes. The system maintains state consistency across different game types including computer games, minigames, demos, game derivatives and Playable Gameplay Highlights (PGH), with each content type potentially having unique state transition rules and requirements. State persistence mechanisms ensure reliable state recovery following interruptions such as network disconnections or device sleep modes.

In some embodiments, the system implements adaptive download methods based on usage patterns and network conditions. For hybrid downloading, the system segments game content, prioritizing essential components for immediate gameplay while scheduling non-critical assets for background download. The streaming component of hybrid delivery utilizes adaptive bitrate technologies, automatically adjusting quality levels based on available bandwidth and device capabilities. The system employs predictive downloading based on user behavior patterns and game structure, pre-fetching likely-to-be-needed content before explicit user requests. Download management includes automatic retry mechanisms with exponential backoff for failed transfers, along with delta updates that minimize data transfer by downloading only changed components. The system supports parallel downloads with configurable concurrency limits, optimizing resource utilization while preventing system overload.

In some embodiments, the system integrates data from multiple device sensors through a sensor fusion framework that ensures accurate and responsive movement detection. The framework processes input from gyroscopes, accelerometers, and magnetometers, applying filtering algorithms to reduce noise and improve movement detection accuracy. Sensor data processing includes motion vector analysis, accounting for device-specific characteristics and environmental factors that might affect sensor readings. The system implements adaptive sensor sampling rates that balance movement detection accuracy with power consumption, adjusting based on current user activity and device state. Cross-validation between different sensor types helps eliminate false positives while ensuring reliable detection of intentional device movements. The sensor integration system maintains calibration states for each sensor type, periodically recalibrating as needed to maintain accuracy over time.

In some embodiments, the system implements comprehensive display management that handles dynamic screen orientation changes and content adaptation. The display handling system maintains consistent visual quality during orientation transitions. This is achieved through progressive resolution scaling and content reflow algorithms. Content rendering adapts to different screen aspect ratios and pixel densities, ensuring optimal visual presentation across diverse device specifications. The system manages multiple display layers including game content, user interface elements, and system overlays, coordinating their presentation and update timing to maintain smooth transitions. Display state management includes handling of partial screen updates, ensuring efficient resource utilization during both static and dynamic content presentation. The system implements frame timing management to maintain consistent frame rates during orientation changes and mode transitions, while coordinating with the device's native display refresh mechanisms.

The system preserves gameplay continuity through state management during mode transitions and interruptions. Game state preservation includes user progress, game configuration, achievement status, and temporal markers that enable precise continuation from previous gameplay points. The continuation system handles both local and cloud-based state management, synchronizing state data across storage systems to enable seamless gameplay resumption across different network conditions. State restoration processes validate saved state integrity before applying it, ensuring consistent game behavior following continuation. The system implements state versioning to handle compatibility across different game versions and updates, maintaining playability while preserving user progress. Gameplay continuation mechanisms operate transparently to the user, automatically managing state transitions during device orientation changes and mode switches.

The system implements robust error handling mechanisms that manage various fault conditions while maintaining system stability and user experience. The system implements graceful degradation instead of complete failure when handling network connectivity issues, resource constraints or hardware limitations. The error handling system includes automatic retry mechanisms with configurable policies for different error types, implementing progressive backoff strategies to prevent system overload during recovery attempts. Error logging and analysis capabilities enable system optimization and problem resolution, while maintaining user privacy and data security. The system provides appropriate user feedback during error conditions, communicating status and recovery progress through the user interface while attempting to maintain basic system functionality. Recovery procedures include state preservation and restoration mechanisms that protect user progress and system stability during error conditions.

The system implements comprehensive performance management that optimizes resource utilization across varying device capabilities and operating conditions. Performance monitoring includes real-time analysis of system metrics including frame rates, response latency, memory usage, and power consumption, adapting system behavior to maintain optimal performance. Resource allocation algorithms prioritize critical operations while managing background tasks to prevent performance degradation during intensive operations such as game loading or state transitions. The system implements predictive performance optimization, pre-allocating resources based on anticipated user actions and game requirements. Performance management includes thermal monitoring and power awareness, adjusting system behavior to prevent device overheating while maintaining acceptable performance levels. The system maintains performance targets for different device categories and usage scenarios, automatically adjusting quality levels and feature availability to match device capabilities.

The terms “comprises”, “comprising”, “includes”, “including”, “having” and their conjugates mean “including but not limited to”. This term encompasses the terms “consisting of” and “consisting essentially of”. As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. Each of the examples as described herein can be combined with one or more other examples. Further, one or more components of one or more examples can be combined with other examples.

Although the detailed description contains many specifics, these should not be construed as limiting the scope of the disclosure but merely as illustrating different examples and aspects of the present disclosure. It should be appreciated that the scope of the disclosure includes other embodiments not discussed in detail above. Various other modifications, changes and variations which will be apparent to those skilled in the art may be made in the arrangement, operation and details of the method and apparatus of the present disclosure provided herein without departing from the spirit and scope of the invention as described herein.

While preferred embodiments of the present disclosure have been shown and described herein, it will be obvious to those skilled in the art that such embodiments are provided by way of example only. Numerous variations, changes, and substitutions will be apparent to those skilled in the art without departing from the scope of the present disclosure. It should be understood that various alternatives to the embodiments of the present disclosure described herein may be employed without departing from the scope of the present invention. Therefore, the scope of the present invention shall be defined solely by the scope of the appended claims and the equivalents thereof.

What is claimed is:

1. A handheld computing device, comprising:
a display configured to present one or more media items;
one or more sensors configured and enabled to detect one or more movements of the handheld computing device or one or more movements of a user;
one or more processors communicatively coupled to the display and to the one or more sensors, wherein the one or more processors are configured and enabled to:
receive one or more movement signals from the one or more sensors; and
process the one or more movement signals to yield one or more movement types; and
automatically transition the mode of one or more computer games from a ‘view mode’ to ‘play mode’ based on the detected one or more movement types or vice versa, wherein the one or more computer games are launched before or during the transition.

2. The handheld computing device, of claim 1, wherein the ‘view mode’ comprises a passive state allowing observation and scrolling through media items representing the one or more computer games without direct interactive control and the ‘play mode’ comprises an active state enabling direct user control and interaction with the one or more computer games.

3. The handheld computing device of claim 1, wherein the one or more computer games are related, respectively, to one of the one or more media items.

4. The handheld computing device of claim 1, wherein the one or more computer games are not directly related to the one or more media items and are linked, respectively, to the one or more media items based on one or more calculation steps, the calculation steps are selected from the group consisting of: randomization, user history, available computer games, preferences.

5. The handheld computing device of claim 1, wherein the one or more movements are limited by a movement threshold.

6. The handheld computing device of claim 1, wherein the one or more movements of the handheld computing device or one or more movements of a user are respectively one or more gestures or one or more rotations.

7. The handheld computing device of claim 6, wherein the one or more gestures of the user are selected from the group consisting of:
Single-Point Contact Gestures; Multi-Point Contact Gestures; Edge-Initiated Gestures; Motion-Based Gestures; one or more taps on the computing device.

8. The handheld computing device of claim 6, wherein the one or more rotations of the handheld computing device comprise an X degrees threshold rotation, wherein X is a configurable parameter.

9. The handheld computing device of claim 6, wherein the one or more rotations are rotations of the handheld computing device or the display from a vertical state of the handheld computing device relative to a reference point to a horizontal state of the handheld computing device relative to the reference point, or vice versa.

10. The handheld computing device of claim 9, wherein in the vertical state the display is in a ‘view mode’ and in the horizontal state the display is in ‘play mode’ or vice versa.

11. The handheld computing device of claim 1, wherein the one or more computer games are selected from the group consisting of: highlight gameplay moments, mini-games, Playable Gameplay Highlight(s) (PGH), games with specific constraints, computer games having derivative forms that maintain interactive entertainment as their primary purpose.

12. The handheld computing device of claim 1, wherein the one or more media items comprise one or more representations of the computer games, selected from the group consisting of: graphics, text, video, images, emojis, stickers, VR (virtual reality), AR (augmented reality), dynamic representations of short preview videos and clips.

13. The handheld computing device of claim 1, wherein the one or more computer games are received or downloaded using streaming techniques comprising Cloud Gaming Streaming services.

14. The handheld computing device of claim 1, wherein the one or more computer games are received or downloaded using a hybrid combination comprising:
downloading part of the one or more computer games or part of elements in the one or more computer games from an external or local storage medium; and
downloading part of the one or more computer games or part of the elements in the computer games using streaming techniques.

15. The handheld computing device of claim 1, wherein the one or more processors comprise a prediction module, the prediction module is configured and enabled to:
predict which of the one or more computer games will be selected and played by the user wherein the one or more predicted computer games are downloaded.

16. The handheld computing device of claim 1, wherein the one or more sensors are selected from the group consisting of: a gyroscope; an accelerometer; a magnetometer; a sensor capable of detecting, measuring or determining the orientation, motion, acceleration, angular velocity, or movement of the handheld computing device.

17. The handheld computing device of claim 1, wherein the handheld computing device comprises a storage unit for storing the one or more media items or one or more computer games.

18. A method comprising:
displaying one or more media items on a display of a handheld computing device;
detecting, by one or more sensors communicatively coupled to one or more processors, one or more movements of the handheld computing device or one or more movements of a user while at least one media item is displayed on the display of the handheld computing device, wherein the movements comprise rotations or gestures;
identifying the movement type by the one or more processors;
automatically transitioning the mode of one or more computer games from a ‘view mode’ to ‘play mode’ based on the one or more movement types or vice versa, wherein the one or more computer games are launched before or during the transition.

19. The method of claim 18, further comprising predicting which of the one or more computer games will be selected and played by the user.

20. The method of claim 18, wherein the ‘view mode’ comprises a passive state allowing observation and scrolling through media items representing the one or more computer games without direct interactive control and the ‘play mode’ comprises an active state enabling direct user control and interaction with the one or more computer games.
